(19) United States
(12) Patent Application Publication
(10) Pub. No.: US 2006/0268812 A1
(43) Pub. Date: Nov. 30, 2006

(54) Method and apparatus for adaptive polling in a wireless communication device

(76) Inventors: Timothy J. Wilson, Rolling Meadows, IL (US); James A. Butler, Bartlett, IL (US)

Correspondence Address: MOTOROLA, INC., 1303 EAST ALGONQUIN ROAD, IL01/3RD, SCHAUMBURG, IL, 60196, US

(21) Appl. No.: 11/141,514

(22) Filed: May 31, 2005

(51) Int. Cl. H04J 3/16

(52) U.S. Cl. 370/346

(57) ABSTRACT

A wireless communication unit (120) polls (200) a radio access point (110) at a certain frequency. The wireless communication unit (120) then determines (210) whether packets are received in response to the polling and determines (220) the percentage of polls resulting in receipt of packets. The wireless communication unit (120) then adjusts (230) the polling frequency to change the number of polls which result in the receipt of packets. Optionally, the wireless communication unit (120) repolls (240) the radio access point (110) when a packet in not received. Then, the wireless communication unit (120) plays (250) the packet at a certain time. Alternatively, the wireless communication unit (120) receives (310) packets without polling and determines (220) a radion access point frequency at which packets arrive at the radio access point (110). The polling frequency is then set (330) to approximately the radio access point frequency.

### TECHNICAL FIELD

The invention relates generally to wireless communication systems and more particularly to systems that send data in wireless communication packets in response to polling from a receiving device.

### BACKGROUND

Wireless communication devices of various kinds are known in the art. Certain of these systems wirelessly send and receive digital data in the form of packets. Examples of such systems include General Packet Radio Service (“GPRS”) related systems, certain Voice over Internet Protocol (“VoIP”) systems, certain wireless Transmission Control Protocol/Internet Protocol (“TCP/IP”) based systems, Code Division Multiple Access (“CDMA”) 2000 systems, and other related systems. When data is transmitted in each of these systems, the data is divided into discrete packets, and each packet is further divided into a number of blocks or frames. The data may be voice data or other data.

In such systems, data packets are transmitted over a network or other data source to a radio access point. The radio access point then transmits the packet wirelessly to a wireless communication unit. The frequency and timing at which the data arrives at the radio access point from the network, however, is often not constant. These timing issues lead to problems in playback of data, for example during the playback of voice data. Such a problem is referred to as jitter in a system.

In certain systems, the radio access point will not transmit a packet until it receives an uplink packet or poll from the wireless communication unit indicating that the packet should be sent. In such systems, the frequency at which the data arrives at the radio access point from the network often differs from the frequency at which the wireless communication unit polls the radio access point, again leading to jitter or playback problems. For example, if a packet arrives at the radio access point after a poll from the wireless communication unit, the wireless communication unit will miss the packet and experience an under run. For voice data, the under run creates a window of silence for the length of the missed packet, thus leading to poor voice quality.

Certain previous systems have employed a buffer memory at the wireless communication unit to dejitter the system. These systems employ a two buffer system such that the wireless communication unit may receive two packets of data before playback of the first packet begins. This system prevents loss of a packet when it arrives at the radio access point after a poll. This dejitter system, however, also builds in a delay of at least the length of at least one packet plus the time to receive and decompress a packet from the radio access point.

### BRIEF DESCRIPTION OF THE DRAWINGS

The above needs are at least partially met through provision of the method and apparatus for adaptive polling in a wireless communication device described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention from the point of view of a wireless communication unit;

FIG. 3 comprises a flow diagram of optional steps relating to the steps of FIG. 2 as configured in accordance with various embodiments of the invention;

FIG. 4 comprises a flow diagram as configured in accordance with various embodiments of the invention; and

FIG. 5 comprises a representation of the transmission of a data packet in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a wireless communication unit polls a radio access point at a certain polling frequency. Next, it is determined whether a packet is received by the wireless communication unit in response to the polling, and a percentage of polls resulting in the receipt of a packet is determined. Then, the certain polling frequency is modified to change the percentage of polls resulting in the receipt of packets.

So configured, a wireless communication unit can reduce the delay in playback of a packet of data while improving the percentage of packets received in response to polling. By improving the percentage of packets received, fewer packets are dropped thereby improving data transmission. For example, the improved data transmission will improve the sound quality of voice transmissions and lessen the delay in playing the sound. Similarly, multimedia playback quality will be increased, and any time-critical data stream will be received with increased quality at a decreased transmission time.

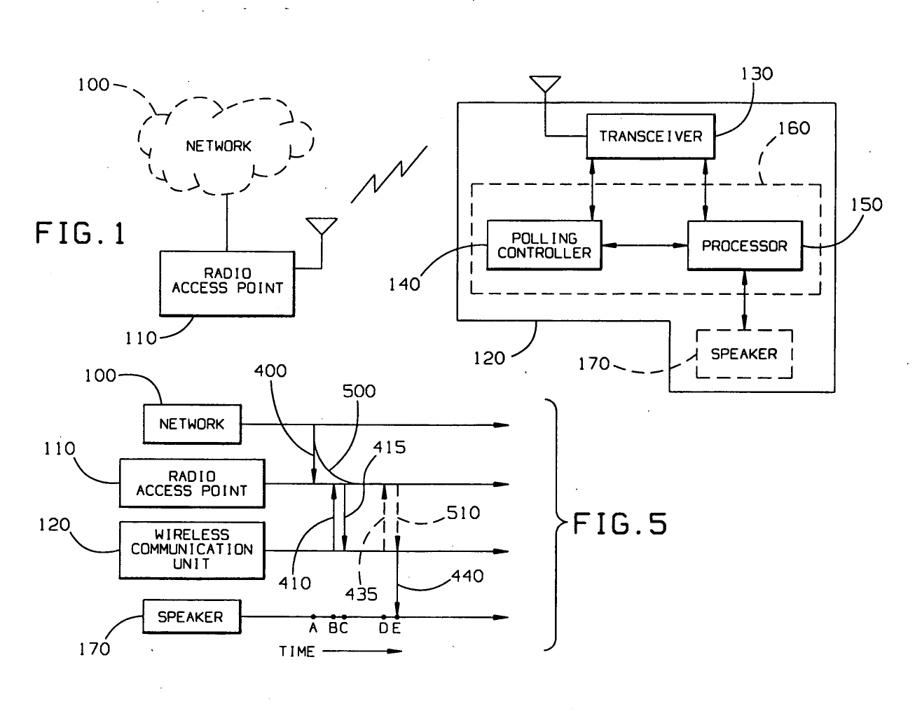

Referring now to the drawings, and in particular to FIG. 1, a network 100 is in communication with a radio access point 110. The network 100 may be any source of data to be sent via wireless packets from the radio access point 110. Such a source may be the Internet or other network through which data is transmitted. The source may alternatively be a data generating device such as a phone, computer, or other device known in the art. Similarly, the radio access point 110 may generate data to be sent and thereby act as its own source of data The radio access point 110 is in wireless communication with a wireless communication unit 120 that includes a transceiver 130, a polling controller 140, and a processor 150. The transceiver 130 sends and receives wireless communication signals including uplink polls and data packets. The wireless communication unit 120 therefore communicates with the radio access point 110 through the transceiver 130.

The polling controller 140 may be a dedicated circuit, software, or other enabling structure able to control the polling, including polling frequency and repolling, from the wireless communication unit 120. The processor 150 runs software routines or otherwise controls the operation of the wireless communication unit 120 including the determination of the receipt of packets in response to polling and the determination of the percentage of polls resulting in the receipt of packets. Alternatively, the polling controller 140 and processor 150 may be an integrated structure 160 or circuit. Optionally, the wireless communication unit 120 also includes a speaker 170 for playback of voice data. One skilled in the art will recognize that a variety of other structures may substitute for the speaker 170 as a playback device such as a video screen for playing multimedia data or a processor for handling other data including time-critical data.

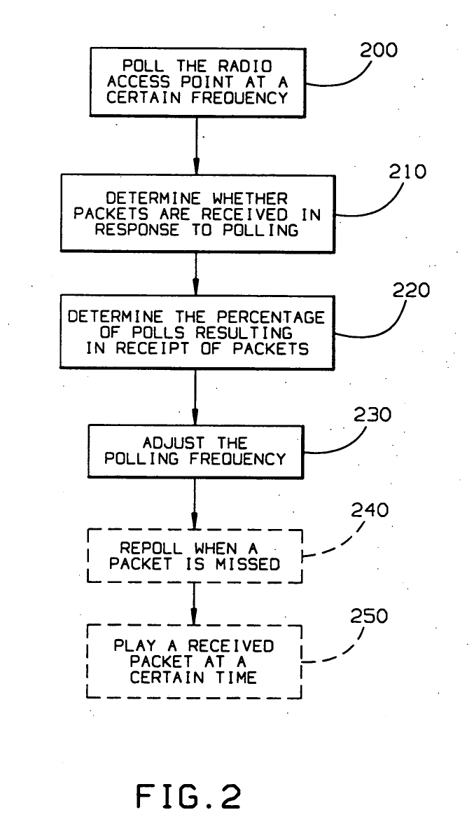

The receipt of packets by the wireless communication unit 120 will be described with reference to FIG. 2. The wireless communication unit 120 polls 200 the radio access point 110 at a certain frequency set by the polling controller 140. Preferably, the wireless communication unit 120 polls 200 the radio access point 110 by sending an uplink packet to the radio access point 110. The radio access point 110 will then send one or more packets to the wireless communication unit 120 in response to receiving the uplink packet. One skilled in the art will recognize other methods of polling operable in connection with the various embodiments.

Then, the processor 150 determines 210 whether packets are received by the wireless communication unit 120 in response to the polling 200. The processor 150 also determines 220 the percentage of polls resulting in receipt of packets. The polling controller 140 will then adjust 230 the polling frequency to change the percentage of polls resulting in the receipt of packets from the radio access point 110. Preferably, the polling frequency is adjusted 230 to drive the percentage of packets received in response to the polls toward a predetermined amount. The predetermined amount can be adjusted by the wireless communication unit 120 in response to various factors known in the art or pre-set such that the percentage is always driven toward the pre-set predetermined amount. Preferably, the predetermined amount is a percentage of packets high enough to maximize the number of packets successfully received while minimizing the delay between the expected arrival of data at the radio access point 110 and polling 200 the radio access point 110 to retrieve the data.

Optionally, the wireless communication unit 120, through the polling controller 140, repolls 240 the radio access point 110 when the processor 150 determines 210 that a packet was not received in response to a poll. The repolling 240 occurs at a certain time. This certain time is preferably approximately a maximum delay time for the packets to be received by the radio access point from the network 100. As such, the time for repolling is set to essentially ensure that the packet not received in response to the regular poll will be received in response to the repolling.

After receiving the packet, the processor 150 plays 250 the received packet at a certain time. Preferably, the certain time for playing 250 the received packet is approximately a maximum delay time for packets to be received by the radio access point 110 from the network 100. Using the preferred playback time, packet playback delay will be minimized to only waiting for the repoll 240 of the radio access point 110 to retrieve a packet not received in response to the regular polling. One skilled in the art will recognize that the playback time may be adjusted to account for time for decompression or other processing of the data before playback. As used herein, the terms “play” and “playback” include such actions as playing voice data through a speaker 170, playing multimedia data on a screen and/or speaker 170, processing or reading a time-critical data stream, or otherwise utilizing improved data transmission efficiencies.

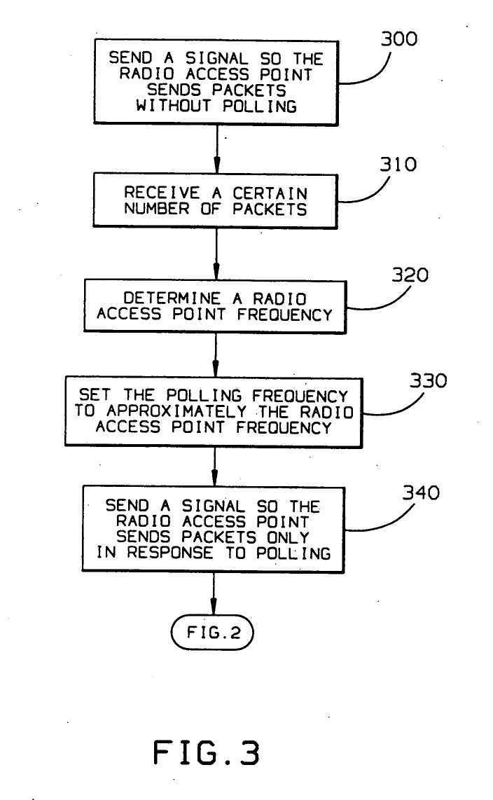

Optionally, the polling frequency of the wireless communication unit 120 may be adjusted as described with reference to FIG. 3. First, the wireless communication unit 120, through transceiver 130, sends 300 a signal to the radio access point 110 directing the radio access point 110 to send packets to the wireless communication unit 120 without polling from the wireless communication unit 120. Next, the wireless communication unit 120 receives 310 a certain number of packets from the radio access point 110. Using the packets received without polling, the processor 150 determines 320 a radio access point frequency. The radio access point frequency is the frequency at which the wireless communication unit 120 receives packets from the radio access point 110. This frequency also corresponds to the rate at which packets arrive at the radio access point 110 from the network 100 because the radio access point 110 sends the packets without waiting for polling from the wireless communication unit 120. One skilled in the art will recognize that a wide range of packets may be received by the wireless communication unit 120 before determining 320 the radio access point frequency depending on the system and the desired accuracy of the measurement.

Next, the wireless communication unit 120, through the processor 150 and/or the polling controller 140, sets 330 the polling frequency of the wireless communication unit 120 to approximately the radio access point frequency. Then, the wireless communication unit 120 sends 340 a signal to the radio access point 110 directing it to send packets only in response to polling from the wireless communication unit 120. Therefore, the wireless communication unit 120 will poll the radio access point 110 at close to the frequency at which the radio access point 110 receives packets, thereby minimizing the jitter in the system.

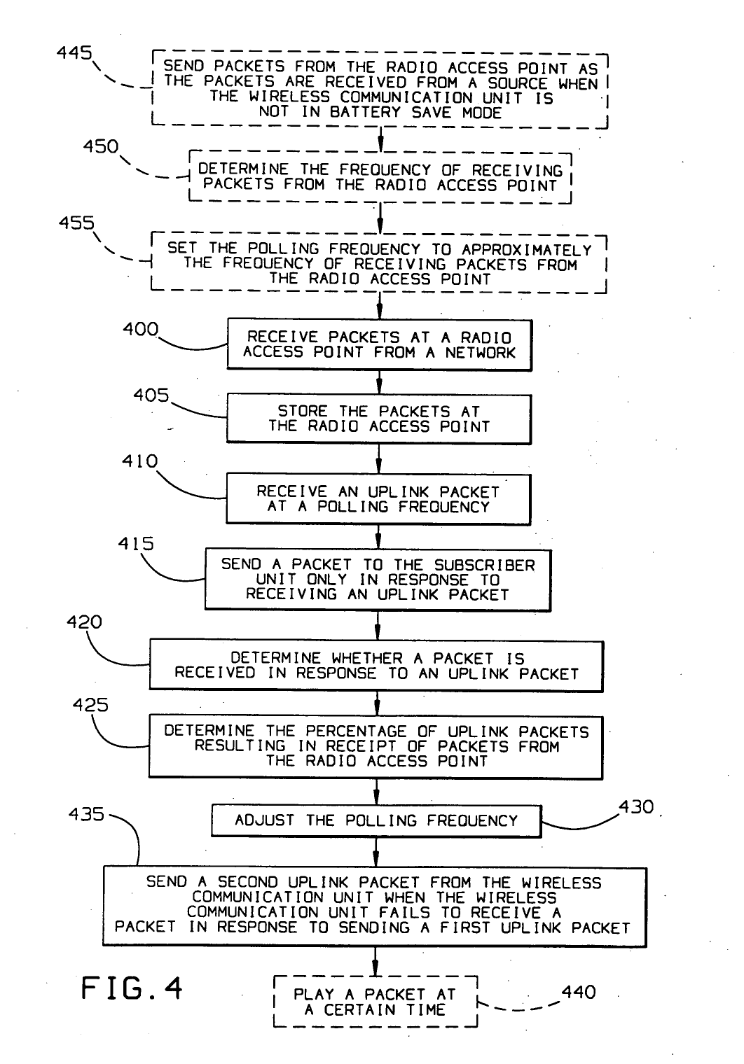

An alternative embodiment will be described with reference to FIG. 4. A radio access point 110 receives 400 packets from a network 100 and stores 405 the packets in a memory. The packets typically arrive at a given frequency with a variable delay time. The radio access point 110 then receives 410 an uplink packet from a wireless communication unit 120 in a battery save mode. One skilled in the art will recognize that polling, or sending uplink packets, conserves battery life, and therefore, the wireless communication unit 120 will poll the radio access point 110 when the wireless communication unit 120 is in a battery save mode. Preferably, the wireless communication unit 120 sends the uplink packets at a certain polling frequency. The radio access point 110, in response to receiving 410 the uplink packet, sends 415 a packet to the wireless communication unit 120.

The processor 150 will then determine 420 whether the wireless communication unit 120 receives a packet in response to a sent uplink packet. The processor 150 will further determine 425 the percentage of uplink packets resulting in receipt of packets from the radio access point 110. Next, the polling controller 140 adjusts 430 the polling frequency to change the percentage of uplink packets resulting in the receipt of packets by the wireless communication unit 120 in response to sending uplink packets. Preferably, the polling frequency is changed to drive the percentage of uplink packets toward a predetermined amount.

If the wireless communication unit 120 fails to receive a packet in response to sending an uplink packet, the wireless communication unit 120 sends 435 a second uplink packet to be received by the radio access point 110. The second uplink packet is preferably sent 435 at approximately the time of the maximum variable delay in receiving 400 a packet at the radio access point 110. Thus, the second uplink packet is likely to retrieve the packet that was missed by the regular polling at the certain polling frequency.

The packet received at the wireless communication unit 120 is played 440 at a certain time after polling the radio access point 110 at the certain polling frequency. In a preferred embodiment, the certain time is approximately the maximum delay time for packets to be received by the radio access point 110 from the network 100. One skilled in the art will recognize that the playback time may be adjusted to account for time to decompress or otherwise process the data before playback.

Optionally, the polling frequency may be set prior to the wireless communication unit's 120 entering a battery save mode. In a battery save mode, the wireless communication unit 120 only receives packets in response to sending uplink packets. In this embodiment, the radio access point 110 sends 445 packets to the wireless communication unit 120, which is not in a battery save mode, as the packets are received from the network 100. The processor 150 then determines the frequency of receiving packets from the radio access point. The polling controller 140 will then set the polling frequency to approximately the frequency of receiving packets from the radio access point 110 before the wireless communication unit 120 enters into a battery save mode. By setting the polling frequency close to the frequency at which the radio access point 110 receives packets, the system minimizes the jitter.

One skilled in the art will recognize that setting the polling frequency while not in the battery save mode may be done at the start of a transmission or during a transmission. Further, the wireless communication unit 120 may change out of a battery save mode to set the polling frequency in the described manner before changing back to a battery save mode during the course of a transmission.

Certain advantages of the above described embodiments are better understood with reference to FIG. 5 and continuing reference to FIG. 4. A radio access point 110 receives 400 a packet from the network at an expected time A because of the given frequency of arrival of packets from the network 100. The packets, however, often arrive at the radio access point 110 with a variable delay. This delay is represented by the line that is denoted by reference numeral 500, which demonstrates a decreasing probability at which a packet will arrive at a certain time after the expected arrival of the packet at time A. Typically, during this window of time after the expected arrival of a packet at the radio access point 110, the radio access point 110 will receive 410 an uplink packet or poll from the wireless communication unit 120 at time B. In response to the poll, the radio access point 110 will either send 415 the received and stored packet at time C or the radio access point 110 will do nothing because the packet from the network 100 did not arrive before the uplink poll.

If the radio access point 110 does not send a packet, the wireless communication unit 120, through processor 150, will determine 420 that a packet was not received in response to sending the uplink packet, and the wireless communication unit 120 will send 435 a second uplink packet at time D. Time D is preferably far enough away from the time of the first uplink packet at time B to maximize the probability of the radio access point's 110 receiving 400 a packet from the network 100. Therefore, the second uplink packet will likely result in the radio access point's 110 sending 510 a packet thereby reducing the number of missed packets by the system.

The wireless communication unit 120 preferably will play the packet at time E regardless of whether the packet was received in response to the first or second uplink packets. By playing the packets at time E, the playback delay in a typical system will be improved. For example, in a typical system, the jitter or variable delay time is at most about 5 milliseconds. Therefore, if a system includes time, for example 5 milliseconds, for decompression or other processing of the data, the playback time or time E will be at around 10 milliseconds from the expected arrival of the packet at the radio access point 110 at time A. In a prior buffer based system, the delay is typically the length of at least one packet in the buffer, for example about 20 milliseconds, plus time for decompression or other processing, about 5 milliseconds, leading to a minimum 25 millisecond delay; a delay more than twice the delay of the system of FIG. 5.

Further, those skilled in the are will recognize that the time for sending the first uplink packet, time B, is dependent on the certain polling frequency. Thus, using the various methods described above, time B can be modified to drive the percentage of polls received in response to the regular polling to a given amount. For example, if too few packets are received in response to the polling, the frequency may be modified to move time B to the right in FIG. 5. So configured, a wireless communication unit 120 will experience fewer missed packets and have a reduced delay in playback of data received from a radio access point 110.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
polling a radio access point from a wireless communication unit at a certain polling frequency;
determining whether a packet is received at the wireless communication unit from the radio access point in response to the polling;
determining a percentage of polls resulting in receipt of packets by the wireless communication unit from the radio access point in response to the polling; and
adjusting the certain polling frequency to change the percentage of polls resulting in the receipt of packets by the wireless communication unit from the radio access point in response to the polling.

2. The method of claim 1 wherein polling a radio access point from a wireless communication unit at a certain polling frequency further comprises sending an uplink packet from the wireless communication unit to the radio access point.

3. The method of claim 1 wherein adjusting the certain polling frequency to change the percentage of polls resulting in the receipt of packets by the wireless communication unit from the radio access point in response to the polling further comprises adjusting the certain polling frequency such that the percentage of polls resulting in the receipt of packets by the wireless communication unit from the radio access point in response to the polling is driven toward a predetermined amount.

4. The method of claim 1 further comprising repolling the radio access point from the wireless communication unit at a certain time after determining that a packet was not received in response to the polling at a certain polling frequency.

5. The method of claim 4 wherein the certain time is approximately a maximum delay time for packets to be received by the radio access point from a network.

6. The method of claim 1 further comprising:
sending a signal to the radio access point such that the radio access point sends packets without polling from the wireless communication unit;
receiving a certain number of packets from the radio access point;
determining a radio access point frequency at which the certain number of packets are received from the radio access point;
setting the certain polling frequency to approximately the radio access point frequency;
sending a signal to the radio access point such that the radio access point sends packets only in response to polling from the wireless communication unit.

7. The method of claim 1 further comprising:
playing a packet received from the radio access point at a certain time after polling the radio access point at the certain polling frequency.

8. The method of claim 7 wherein the certain time after polling the radio access point at the certain polling frequency is approximately a maximum delay time for packets to be received by the radio access point from a network.

9. The method of claim 7 wherein playing a packet received from the radio access point at a certain time after polling the radio access point at the certain polling frequency further comprises one or more of playing voice data, playing multimedia data, and processing a time-critical data stream.

10. A method comprising:
receiving a packet at a radio access point from a network at a given frequency with a variable delay time;
storing at the radio access point packets from the network until the packets are sent to a wireless communication unit;
receiving at the radio access point an uplink packet at a certain polling frequency from the wireless communication unit; and
sending a packet from the radio access point to a wireless communication unit only in response to receiving an uplink packet from the wireless communication unit when the wireless communication unit is in a battery save mode.

11. The method of claim 10 further comprising:
determining whether a packet is received at the wireless communication unit from the radio access point in response to receiving an uplink packet;
determining a percentage of uplink packets resulting in receipt of packets by the wireless communication unit from the radio access point;
adjusting the certain polling frequency to change the percentage of uplink packets resulting in the receipt of packets by the wireless communication unit from the radio access point; and
receiving a second uplink packet from the wireless communication unit when the wireless communication unit fails to receive a packet in response to sending a first uplink packet such that the second uplink packet is received from the wireless communication unit at approximately a maximum of the variable delay time after the wireless communication unit sent the first uplink packet.

12. The method of claim 11 wherein adjusting the certain polling frequency to change the percentage of uplink packets resulting in the receipt of packets by the wireless communication unit from the radio access point further comprises adjusting the certain polling frequency to drive the percentage of uplink packets resulting in the receipt of packets by the wireless communication unit from the radio access point toward a predetermined amount.

13. The method of claim 11 further comprising:
sending packets from the radio access point to the wireless communication unit as the packets are received from the network when the wireless communication unit is not in a battery save mode;
determining the frequency of receiving packets at the radio access point; and
setting the certain polling frequency of the wireless communication unit to approximately the frequency of receiving packets at the radio access point.

14. The method of claim 11 further comprising:
playing a packet received from the radio access point at a certain time after polling the radio access point at the certain polling frequency.

15. The method of claim 14 wherein the certain time after polling the radio access point at the certain polling frequency is approximately a maximum delay time for packets to be received by the radio access point from a network.

16. The method of claim 14 wherein playing a packet received from the radio access point at a certain time after polling the radio access point at the certain polling frequency further comprises one or more of playing voice data, playing multimedia data, and processing a time-critical data stream.

17. A wireless communication unit capable of wireless communication with a radio access point, the wireless communication unit comprising:
a transceiver capable of wireless communication with the radio access point;
a processor circuit operably coupled to the transceiver capable of tracking a receipt of packets from the radio access point; and
a polling controller operably coupled to the transceiver and the processor circuit capable of sending polling signals at a plurality of polling frequencies via the transceiver and in response to the processor circuit.

18. The wireless communication unit of claim 17 wherein the processor circuit further comprises:
means for determining whether a packet is received at the wireless communication unit from the radio access point in response to the polling signals;
means for determining a percentage of polling signals resulting in receipt of packets by the wireless communication unit from the radio access point in response to the polling signals.

19. The wireless communication unit of claim 18 wherein the polling controller further comprises means for adjusting at least one of the polling frequencies to change the percentage of polls resulting in the receipt of packets by the wireless communication unit from the radio access point in response to the polling signals.

20. The wireless communication unit of claim 17, further comprising means for repolling the radio access point from the wireless communication unit at a certain time after determining that a packet was not received in response to the polling at a certain polling frequency.

21. The wireless communication unit of claim 17, further comprising:
means for sending a signal to the radio access point such that the radio access point sends packets without polling from the wireless communication unit;
means for receiving a certain number of packets from the radio access point;
means for determining a radio access point frequency at which the certain number of packets are received from the radio access point;
means for setting the certain polling frequency to approximately the radio access point frequency; and
means for sending a signal to the radio access point such that the radio access point sends packets only in response to polling from the wireless communication unit.
